(19) United States
(12) Patent Application Publication
(10) Pub. No.: US 2026/0239109 A1
(43) Pub. Date: Aug. 13, 2026

(54) SYSTEM AND METHODS FOR DELEGATED TRAFFIC MANAGEMENT

(71) Applicant: Huawei Technologies Co., Ltd., Shenzhen (CN)

(72) Inventors: Kaippallimalil Mathew John, Carrollton, TX (US); Yunsong Yang, San Diego, CA (US); Zhixian Xiang, Frisco, TX (US); Khosrow Tony Saboorian, Plano, TX (US); Abbas Kiani, Vieanna, VA (US)

(21) Appl. No.: 19/637,923

(22) Filed: Apr. 2, 2026

Related U.S. Application Data
(63) Continuation of application No. PCT/US2024/049824, filed on Oct. 3, 2024.
(60) Provisional application No. 63/587,844, filed on Oct. 4, 2023.
(60) Provisional application No. 63/674,075, filed on Jul. 22, 2024.

(51) Int. Cl. H04W 28/10; H04L 12/46; H04W 28/02

(52) U.S. Cl. CPC H04W 28/10; H04L 12/4633; H04W 28/0268; H04L 2212/00

(57) ABSTRACT

In accordance with implementations, a communication device communicates a traffic management and monitoring (TMM) message over a TMM transport channel. The TMM transport channel is a user plane-based transport channel using a TMM quality of service (QoS) flow different from a user data QoS flow for user data transmission, or using a data radio bearer (DRB) between the UE and a base station and a general packet radio service tunneling protocol (GTP) user (GTP-U) protocol between the base station and the UPF network entity. Alternatively, the transport channel is a control plane-based transport channel using a non-access stratum (NAS) signaling between the UE and a session management function (SMF) network entity and a packet forwarding control protocol (PFCP) between the SMF network entity and the UPF network entity.

### PRIORITY CLAIM AND CROSS-REFERENCE

This patent application is a continuation of International Application No. PCT/US2024/049824, filed on Oct. 3, 2024, and entitled “System and Methods for Delegated Traffic Management,” which claims priority to U.S. Provisional Application No. 63/587,844, filed on Oct. 4, 2023, and entitled “System and Methods for Delegated Traffic Management,” and U.S. Provisional Application No. 63/674,075, filed on Jul. 22, 2024, and entitled “System and Methods for Delegated Traffic Management,” applications of which are hereby incorporated by reference herein as if reproduced in their entireties.

### TECHNICAL FIELD

The present disclosure relates generally to a system and method for delegated traffic management, and, in particular embodiments, to a system and method for transport container usage in delegated traffic management.

### BACKGROUND

In various contexts, in traffic management, a slow start phase suffers from increased end-to-end (E2E) queuing (added latency) and possible packet loss. This technical issue is problematic for traffic that requires low latency and high throughput and incurs Internet Protocol (IP) layer handovers (e.g., user mobility). With highly distributed user plane functions (UPFs) in the network and more user mobility, handoffs can be more frequent and cause additional latency, jitter, and loss of packets.

Embodiments of the present disclosure provide technical improvements and advantages to these technical problems.

### SUMMARY

Technical advantages are generally achieved, by implementations of this disclosure which describe methods, apparatus, and system.

In accordance with implementations, a communication device communicates a transport management message for flow regulation report (FRR) using a traffic management and monitoring (TMM) transport container based on extensions to a third generation partnership project (3GPP) control plane channel or a 3GPP user plane channel. A user plane function (UPF) network entity provides a user equipment (UE) with bandwidth or other flow conditions between the UPF network entity and the UE.

In accordance with some implementations, the communication device may be one of the UPF network entity or the UE.

In accordance with some implementations, the transport management message may include a command to the UPF network entity for an end-to-end (E2E) internet protocol (IP) flow that belongs to a protocol data unit (PDU) session of the UE.

In accordance with some implementations, a session management function (SMF) network entity may authorize a flow regulation request message for the FRR based on policies or ownership of the E2E IP flow that belongs to the PDU session of the UE.

In accordance with some implementations, an SMF network entity may delegate authorization of a flow regulation request message for the FRR to the UPF network entity based on policies or ownership of the E2E IP flow that belongs to the PDU session of the UE.

In accordance with some implementations, the transport management message for the FRR may indicate a change in bandwidth constraints for the E2E IP flow.

In accordance with some implementations, the communication device may be the UE. An application in the UE may be eligible to requesting a change in flow regulation. When the application starts, the application in the UE may initiate setup of the FRR in the UE to request the change in the flow regulation attributes from a network device attributes.

In accordance with some implementations, the application in the UE may determine eligibility of the application to request for the change in the flow regulation attributes from the network device based on UE route selection policies (URSP).

In accordance with some implementations, the UE may determine the application corresponding to the transport management message for the FRR based on IP flow information, the IP flow information including a 5-tuple of an E2P IP flow.

In accordance with some implementations, the communication device may be the UPF network entity. The UPF network entity may configure the FRR that instructs a control program of the UPF network entity to change E2E flow shaping or scheduling attributes. The UPF network entity may send or receive the transport management message for the FRR.

In accordance with some implementations, the TMM transport container may use non-access stratum (NAS) message extensions between the UE and an SMF network entity and use packet forwarding control protocol (PFCP) extensions between the SMF network entity and the UPF network entity.

In accordance with some implementations, the TMM transport container may be in one of (i) a dedicated quality of service (QoS) flow, (ii) a service data adaption protocol (SDAP) control channel, or (iii) a packet data convergence protocol (PDCP) control protocol data unit (PDU).

In accordance with some implementations, the TMM transport container may be carried in the dedicated QoS flow separate from user data QoS flows.

In accordance with some implementations, the dedicated QoS flow and the user data QoS flows may be mapped to a single data radio bearer (DRB).

In accordance with some implementations, the dedicated QoS flow and user data QoS flows may be mapped to separate data radio bearers DRBs.

In accordance with some implementations, the TMM transport container may be carried in an SDAP control PDU. The SDAP control PDU may include a control PDU type field indicating that the SDAP control PDU is an SDAP TMM Transfer control PDU.

In accordance with some implementations, the TMM transport container may be carried in the PDCP control PDU. The PDCP control PDU may include a PDU type field indicating that the PDCP control PDU is a TMM transfer control PDU. Or, the PDCP control PDU may be a generic message transfer control PDU that includes a message type field indicating that a message type is carried in a message payload field.

In accordance with some implementations, the bandwidth or other flow conditions may be carried in the TMM transport container. The UPF network entity may provide the TMM transport container to the UE such that the UPF network entity provides the TMM transport container directly to the UE without any other network entity relaying the TMM transport container or the UPF network entity provides the TMM transport container to the UE via a second network entity without the TMM transport container being modified by the second network entity.

In accordance with some implementations, the second network entity may be an SMF network entity.

In accordance with some implementations, the extensions to the 3GPP control plane channel or the 3GPP user plane may be implemented at a layer lower than an IP layer.

In accordance with implementations, a communication device communicates between a user equipment (UE) and a user plane function (UPF) network entity using a transport container for carrying internet protocol (IP) flow and traffic management information. The transport container uses non-access stratum (NAS) message extensions between the UE and a session management function (SMF) network entity and uses packet forwarding control protocol (PFCP) extensions between the SMF network entity and the UPF network entity.

In accordance with some implementations, the communication device may be one of the UPF network entity or the UE.

In accordance with implementations, a communication device communicates between a user equipment (UE) and a user plane function (UPF) network entity using a transport container for carrying internet protocol (IP) flow and traffic management information. The transport container is in one of (i) a dedicated quality of service (QoS) flow, (ii) a service data adaption protocol (SDAP) control channel, or (iii) a packet data convergence protocol (PDCP) control protocol data unit (PDU).

In accordance with some implementations, the communication device may be one of the UPF network entity or the UE.

Example advantages of implementations of the present disclosure include improvements in traffic management, including reducing latency, possible packet loss, and other technical issues associated with slowly starting ramping up while targeting not to overshoot an available capacity.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is an example representation of NAS and RRC signaling from the UE to the 5GS;

FIG. 2 is an example representation of a general model of UE and UPF to support TMM and FRR, in accordance with some implementations;

FIG. 3 is an example representation of protocol stacks for TMM transport over NAS and PFCP, in accordance with some implementations;

FIGS. 4A-4B show an example representation of a NAS-TMM with FRR flow diagram, in accordance with some implementations;

FIG. 5 is an example representation of a QoS flow based TMM/FRR flow diagram, in accordance with some implementations;

FIG. 6A is an example representation of an existing format of SDAP End-Marker control PDU;

FIG. 6B is an example representation of an existing format of UL SDAP data PDU and new format of DL SDAP data PDU;

FIG. 6C is an example representation of a format of new UL and DL SDAP control PDU, in accordance with some implementations;

FIG. 7 is an example representation of an SDAP Control PDU for carrying TMM payload over the Uu interface, in accordance with some implementations;

FIGS. 8A-8B show an example representation of an SDAP Control PDU/TMM and GTP-U extension flow diagram, in accordance with some implementations;

FIG. 9A is an example representation of a format of UL and DL PDCP TMM transfer control PDU, in accordance with some implementations;

FIG. 9B is an example representation of a format of UL and DL PDCP Generic Message Transfer control PDU, in accordance with some implementations;

FIG. 10 is an example representation of a PDCP control PDU for carrying TMM payload over the Uu interface, in accordance with some implementations;

FIGS. 11A-11B show an example representation of a PDCP control PDU/TMM and GTP-U extension flow diagram, in accordance with some implementations;

FIG. 12A illustrates a flow chart of a method performed by a communication device, in accordance with some implementations;

FIG. 12B illustrates a flow chart of a method performed by a communication device, in accordance with some implementations;

FIG. 12C illustrates a flow chart of a method performed by a communication device, in accordance with some implementations;

FIG. 13 illustrates an example communications system, in accordance with some implementations;

FIG. 14 illustrates an example communications system, in accordance with some implementations;

FIGS. 15A and 15B illustrate example devices that may implement the methods and teachings, according to this disclosure, in accordance with some implementations; and

FIG. 16 is a block diagram of a computing system that may be used for implementing the devices and methods disclosed herein.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

Internet transports use end-to-end (E2E) congestion control (CC) to constrain the rate of transmission of a flow to the bandwidth-delay product (BDP). This is determined by slowly ramping up (“slow-start-phase”) and increasing capacity without overshooting the available capacity and resulting in packet drops. During the slow start phase, there may be increased E2E queuing (e.g., added latency) and possible packet loss. This is problematic for traffic that requires low latency and high throughput and incurs IP layer handovers (e.g., user mobility). With highly distributed UPFs in the network and more user mobility, handoffs can be more frequent and cause additional latency, jitter, and loss of packets.

Current procedures are considering how to avoid an excessively conservative startup phase. For example, https://datatracker.ietf.org/doc/draft-ietf-tsvwg-careful-resume/proposes an invalidated jump to a reasonably high level of capacity, and to retreat if needed. However, this procedure requires an estimate of capacity available for the flow after handover in the new bottleneck links (e.g., a radio link). A user/host may use configured values but when bandwidth values are dynamic such as in a 5th generation (5G) radio network, a configured value will not suffice. The bandwidth available for a flow is dynamic due to the nature of the radio link, and the number of users on the link and network attachment (e.g., PDU session)/flow policies.

Dynamic bandwidth value for flows may be provided over an application layer transport but would require a proxy connection and encryption (and key management) between the host/UE and the router/UPF. One technical approach would be to extend the existing 3GPP layer 2 signaling framework to support this exchange between the UPF and UE. This technical approach is described this disclosure.

A high-level overview of the control signaling between the user equipment (UE) and RAN/5GC is provided below.

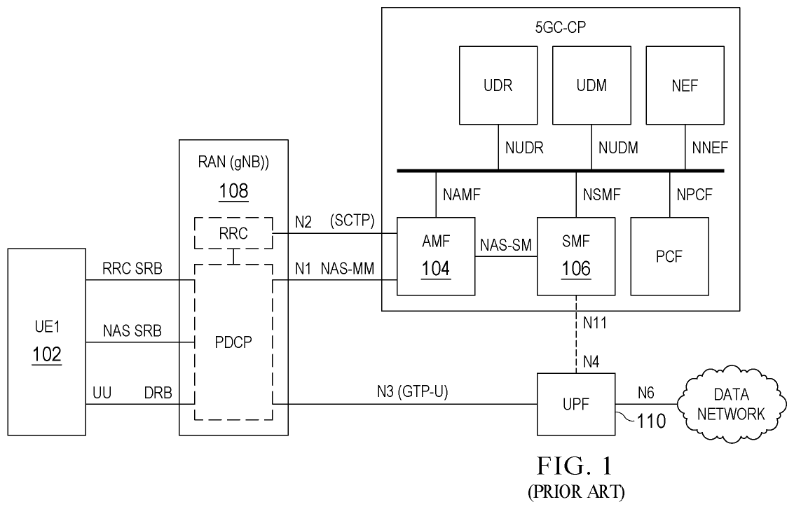

FIG. 1 is an example representation of non-access stratum (NAS) and radio resource control (RRC) signaling from the UE to the 5G system (5GS). NAS signaling messages are sent between the UE 102 and the 5G core (5GC) (e.g., access and mobility management function (AMF) 104, session management function (SMF) 106) over the N1/N11 interface for NAS mobility management (NAS-MM) and NAS session management (NAS-SM). The AMF 104 uses the N2 interface to signal UE parameters that the gNB 108 uses for the UE. The UE 102 and the gNB 108 use RRC signaling to manage radio resources for the UE 102.

Signaling radio bearers (SRBs) are used to carry the signaling messages over the Uu interface between the UE 102 and the gNB 108. All signaling is handled in a centralized manner where the SMF 106 (for session management) conveys policies and other control messages to the UPF 110 via the packet forwarding control protocol (PFCP) over the N4 interface. However, there is no signaling context or mechanism to signal information directly between the UE 102 and UPF 110. Requirements for network collaboration signaling defines this technical issue and related requirements in depth.

The protocol data unit (PDU) session that the UE 102 and the 5GS set up may be used to carry one or many E2E flows, each E2E flow identified by an IP 5-tuple, and has the IP source address that 5GS has given to the UE/PDU session. The E2E flow may have one or more quality of service (QoS) flows associated based on the policy rules assigned to the E2E flow of the PDU session. The 5G user plane (e.g., UPF 110, gNB 108) shapes and schedules packets in these E2E flows based on policies, conditioning that estimates flow behavior and to maximize overall network utilization. The effect is that different E2E flows of a PDU session are not always served at the nominal rates (e.g., guaranteed bit rate (GBR), maximum flow bit rate (MFBR)) or even proportionally across E2E flows within a PDU session.

A technical solution is provided for using a direct transport channel between the UE and the UPF to carry signaling messages used for managing QoS flow(s) between them. Various implementations of the solution are described herein with new functional entities added in the UE and the UPF and various signaling procedures and protocols involving the UE, the UPF, and various other network nodes such as the gNB, the AMF, and SMF.

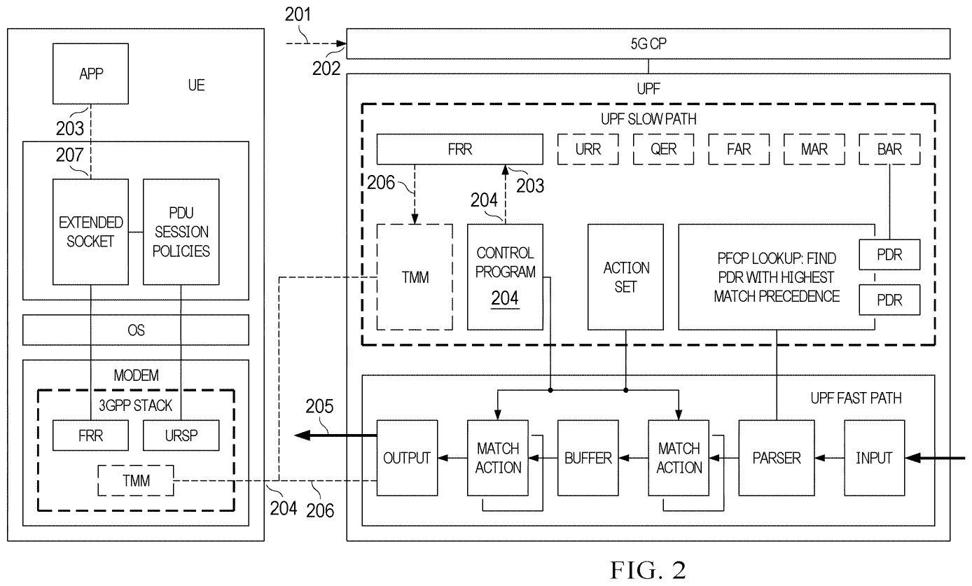

FIG. 2 shows a general model of various functional entities in the UE and the UPF and the signaling procedure between them to support transport management and monitoring (TMM) and flow regulation rules/reports (FRR).

The UPF configuration may include Packet Detection Rules (PDR) that are applied to packets of an E2E flow (identified by an IP 5-tuple, DiffServ code point (DSCP), etc.). The rules in TS 29.244 include Forwarding Action Rules (FAR), Multiple Access Rules (MAR), QoS Enforcement Rules (QER), Buffer Action Rules (BAR) and Usage Reporting Rules (URR). However, none of the current rules provide a means for providing information of the UE bandwidth (BW) to calculate a safe congestion window (cwnd). Hence, in various embodiments, a Flow Regulation Report (FRR) mechanism is introduced for providing the bandwidth information from the UPF to the UE, which may be used by the UE (e.g., after a handover) to speed up slow-start in the new cell serving the UE. An FRR entity is configured in both the UE and the UPF for generating (by the UPF) or handling (by the UE) the FRR information. A TMM entity is also configured in both the UE and the UPF for handling signaling messages that carries the FRR information. The TMM transport channel may also be used for conveying other types of higher layer information (e.g., the PDU Set Information of extended reality (XR) packets) between the UE and the UPF. In this disclosure, the TMM transport channel and TMM transport container are used interchangeably.

The mechanisms described in this disclosure may be intended for applications that are highly sensitive to changes in bandwidth such as video streaming or any application that requires high bandwidth and low latency. Thus, these applications can be FRR aware. FRR aware applications can react to the shaping employed in the network; however, these mechanisms do not influence or change the way the network shaping itself works. These methods are used to report the information for use by applications that may need the information and subscribe to it. The reported information in FRR (i.e., currently bandwidth) is used by the network layer in the UE in flow ‘rate information’ that is used to feedback to the server (which paces downstream flows). Alternatively, an application at the UE (such as adaptive bit rate (ABR) streaming) may use this information to determine the rate and then request the server to send at a rate that matches the available bandwidth.

In various implementations, the procedure to support TMM and FRR includes the following operations:

Operation 201: TMM and/or FRR Capability Information Exchange and Negotiation During Registration

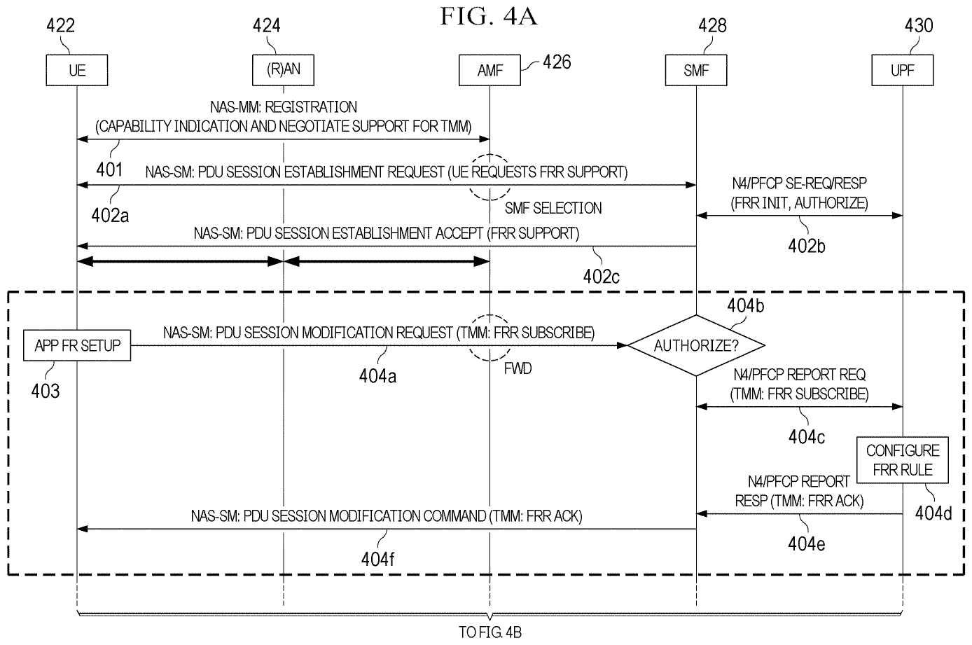

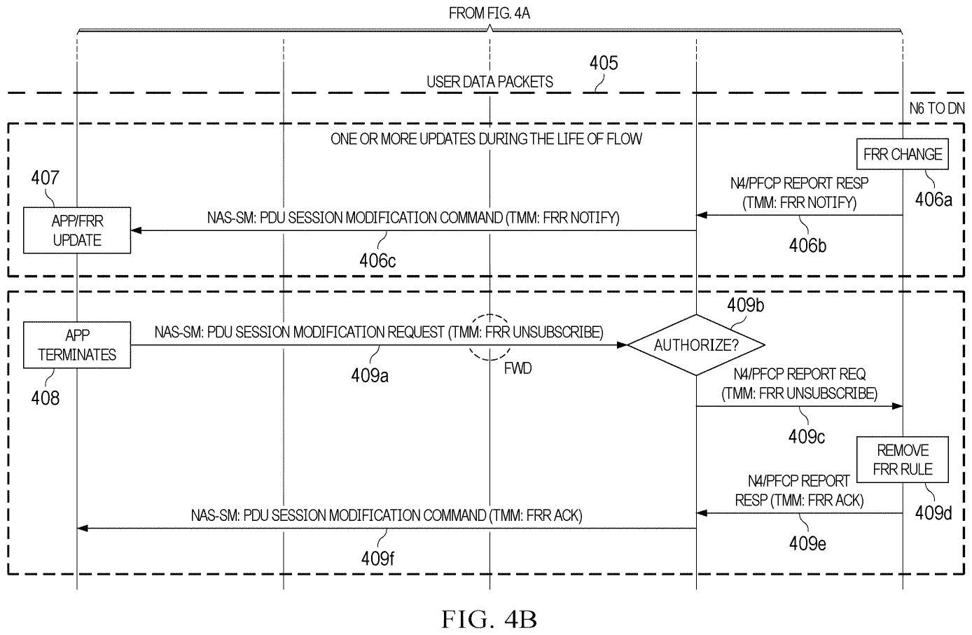

During registration procedure, the UE indicates its capability of supporting TMM and FRR to the network and negotiates support for TMM with the network (e.g., the network may, based on the indication, select an AMF capable of supporting TMM to serve the UE, and the selected AMF may further prepare to select an TMM-capable SMF to serve the PDU session, which is yet to be requested by the UE). As the UPF is not involved in Operation 201, more details of Operation 201 are descried later in FIGS. 4, 5, 8, and 11.

Operation 202: Configuration of TMM and/or FRR Support (Including Establishing a Transport Channel for TMM) During PDU Session Setup

During PDU session setup procedure, the application in the UE uses extended socket options to trigger a request for FRR support to be sent to the network, (e.g., the request being including in the PDU Session Setup Request message). The network configures UE route selection policy (URSP) information that indicates this eligibility (e.g., Route Selection Descriptor in addition to DNN/NSSAI/3GPP_access, also indicates eligibility for FRR). The SMF authorizes for the control plane (CP) or instructs UPF to authorize FRR for the PDU session (e.g., E2E flows with IP address of PDU session). The authorization rules constrain the FRR requests from the UE to be limited to a subset of E2E flows of the PDU session (e.g., all flows of PDU session (IP address), 5-tuple/PDU session flows to specific destinations). Rules for destination in 5-tuple of a PDU session E2E flow may be based on pre-configured information about a destination server IP address or Server Name Indication (SNI). Subsequently, support of TMM and FRR are initialized in both the UE and the UPF (including configuring the respective TMM entity and FRR entity in them) and a TMM transport channel is established between them.

### Operation 203: Application Subscription to FRR

The application (App) in the UE requests FRR for its E2E flow identified by an IP 5-tuple by either subscribing or setting callbacks to reports on that FRR, which triggers the next operation.

### Operation 204: Configuration of FRR in Network

The FRR entity in the UE initiates a FRR request to be sent to the UPF. The FFR request is encapsulated in a TMM message and sent to the UPF via the TMM transport established. The UPF sets up FRRs and initializes the control program (that includes shaping) to report changes in regulating the specified E2E flow. When an FRR is setup (either in initial PDU setup/modification or after handover), an FRR report is sent to the UE with information indicating the current bandwidth (BW) of the E2E flow as in step 6 below.

### Operation 205: PDU/Data Transfer

### Operation 206

When the UPF control program initiates a change in handling an E2E flow with an FRR (e.g., either due to change in policy or due to other dynamic control including shaping multiple flows), it notifies the change to the FRR entity. The UPF receives information that represents resources and capacity available in the gNB. This may be via the operations and management (OAM) or policy control function (PCF)/policy per E2E flow. The FRR entity assembles the bandwidth (or other) information, IP 5-tuple for E2E flow, etc., into an FRR and provides the FRR to the TMM entity.

The TMM entity encapsulates the FRR in a TMM message and sent the TMM message to the TMM entity in the UE via the TMM transport channel.

### Operation 207

The IP 5-tuple in the FRR is used by the UE to find binding between the received FRR and the associated E2E flow/application. The information (such as bandwidth, etc.) in the FRR is published (based on earlier subscription) or a callback to the application/network service interface (e.g., socket options, published by a service broker in the UE).

This disclosure extends and adds the following aspects:

1. Transport Channel for Traffic Management and Monitoring (TMM)

2. Flow Regulation Report (FRR). FRR messages between UE and UPF as well as FRR (rules) in UPF that are triggered when flow regulation aspects changed for E2E flows that have a corresponding rule.

3. NAS-SM extension to convey the TMM messages between the UE and the SMF as a part of a CP-based embodiment of the TMM transport and N4/PFCP messages to convey the TMM messages between the SMF and the UPF as another part of the CP-based embodiment of the TMM transport. This CP-based TMM transport mechanism for conveying FRR messages or other user plane higher layer control messages between the UE and the UPF over the NAS and N4 interfaces is described in detail below.

4. A UP-based TMM transport mechanism for conveying FRR messages or other user plane (UP) higher layer control messages between the UE and the UPF over a dedicated QoS flow is described in detail below.

5. Another UP-based TMM transport mechanism for conveying FRR or other user plane higher layer control messages between the UE and the UPF using in-band signaling mechanisms of the General Packet Radio Service Tunneling Protocol (GTP) User (GTP-U) protocol (over the N3 interface) and of the Service Data Adaption Protocol (SDAP) (over the Uu interface) is described in detail below.

6. Yet another UP-based TMM transport mechanism for conveying FRR or other UP higher layer control messages between the UE and the UPF using in-band signaling mechanisms of the GTP-U protocol (over the N3 interface) and of the Packet Data Convergence Protocol (PDCP) (over the Uu interface) is described in detail below.

Flows in this disclosure may be used to refer to E2E Flows (with e.g., IP 5-tuple) or 3GPP QoS Flows. When a “flow” is not qualified, it refers to an E2E flow. The following sections describe the transport channel and flow regulation in detail.

### TMM Transport Mechanism for Conveying FRR or Other Signaling Messages Between the UE and the UPF

This section describes the transport of Traffic Management and Monitoring (TMM) between the UE and UPF. Four example implementations for the transport mechanism are described and all of them use the same association (i.e., a TMM context between UE and UPF). This is understood as delegated control as the SMF, which can be the controller, explicitly allows setup for delegated control messages between UE and UPF.

### Implementation of CP-Based TMM Transport Channel Using Extended NAS and PFCP Signaling Messages

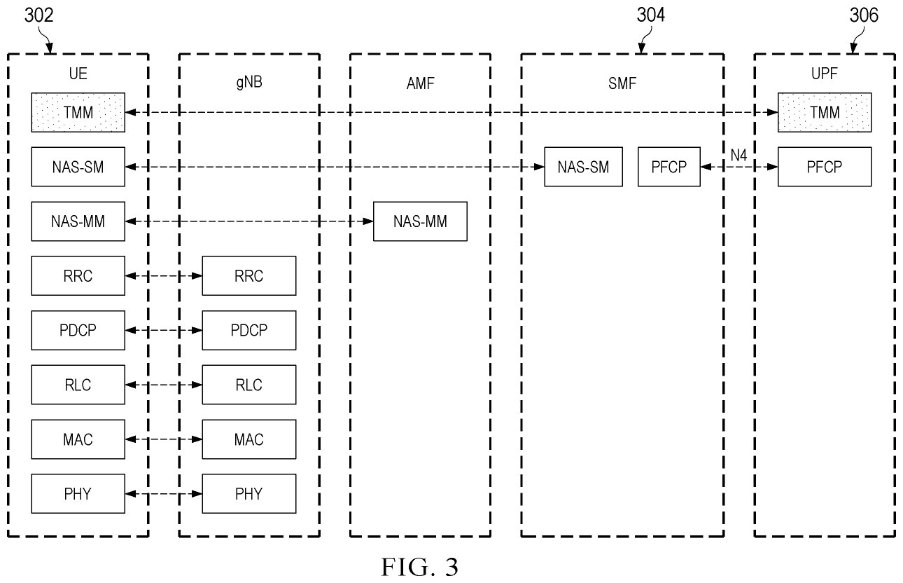

FIG. 3 illustrates the protocol stacks for a CP-based TMM transport mechanism, where a TMM protocol offers the end-to-end transport service between the UE and the UPF for FRR or other signaling messages, in accordance with some implementations. In this CP-based implementation, the TMM protocol uses the transport service offered by the NAS protocol and the N4/PFCP below it. More specifically, a TMM message is encapsulated in a new container field in specific NAS-SM messages (such as PDU Session Setup Request/Response messages, PDU Session Modification Request/Response messages, etc.) to be carried between the UE 302 and the SMF 304 and encapsulated in another new container field in specific N4/PFCP messages between the SMF 304 and the UPF 306. The SMF 304 may verify that the UE 302 has access (or other policy permissions) for the actions in the FRR control messages. During the initialization, the SMF 304 also authorizes the UPF 306 to support FRR for that PDU session. These relate to the scope of E2E flow(s) (i.e., was the UE/PDU session granted the IP address that is in the 5-tuple requested) or other subscription or other policies which determine if the UE/PDU session is allowed to request FRR control. The SMF 394 forwards the FRR messages that are sent over the TMM channel to the UFP 306 over PFCP (e.g., Request/Response for the PFCP session). In addition to FRR messages, the TMM messages may be also used to carry other signaling messages between the UE 302 and the UPF 306 (e.g., to indicate the PDU Set information for a XR service flow).

TMM transport using a NAS transport with a new container (e.g., TMM container) coupled with TMM transport over PFCP over N4 interface can realize a direct delegated control between UE 302 and UPF 306.

The sequence of operations to set up a TMM transport over NAS and PFCP is shown in FIGS. 4A-4B, in accordance with some implementations.

In the operation 401, the UE 422 registers with the AMF 426 as described in TS 23.502, 4.2.2 (TS 24.501, 5.5 GMM procedures). The UE 422 indicates that it is capable of supporting TMM (and FRR), and the AMF 426 acknowledges the TMM support.

In the operation 402, at the sub-operation 402a, the UE 422 initiates the PDU session establishment using procedures described in TS 23.502, 4.3 (TS 24.501, section 6 5GSM procedures), and the AMF 426 selects the SMF 428 that is TMM capable. PDU session setup includes request to SMF 428 for the TMM/FRR support.

At the sub-operation 402b, the SMF 428 selects a TMM/FRR-capable UPF 430 to serve the PDU Session. The SMF sends a PFCP Session Establishment Request (SE-Request) initializes the FRR for the PDU session, and delegates authorization of the FRR of E2E flows belonging to the PDU session to the UPF 430. The UPF 430 sends the PFCP Session Establishment Response (SE-Response) with the FRR that it supports.

In one example, FRR reports include the bandwidth (BW).

At the sub-operation 402c, the SMF 428 acknowledges FRR capabilities and support and configures, via the (R)AN (e.g., a gNB) 424, the URSP rule in the UE 422 indicating FRR eligibility (see operation 202 in FIG. 2).

In the operation 403, the application in the UE 422 starts.

If the application is FRR aware (e.g., video streaming with ABR), the application requests FRR support from underlying operating system (OS) services.

If the application relies on the OS networking for congestion control (or user space services as in Quick UDP Internet Connections (QUIC), the application requests FRR using socket extensions.

In the operation 404, at the sub-operation 404a, the application's request for FRR in the previous step results in triggering the 3GPP module FRR setup. The UE 422 sends a PDU Session Modification Request with TMM (e.g., FRR subscribe message and FRR configuration that includes IP flow (5-tuple) and FRR report requested (i.e., bandwidth change)).

At the sub-operation 404b, the SMF 428 validates the FRR request to ensure that the UE 422 is allowed to request for capabilities for the IP flow.

At the sub-operation 404c, SMF 428 sends an N4/PFCP Report Request to the UPF 430 to configure the FRR rule and reporting.

At the sub-operation 404d, the UPF 430 initializes the control program to report bandwidth changes to the FRR module.

At the sub-operation 404e, the UPF 430 sends N4/PFCP Report Response to the SMF 428 acknowledging the configuration of FRR.

At the sub-operation 404f, the SMF 428 sends the PDU Session Modification Command with TMM/FRR acknowledgement to the UE 422. The UE 422 responds to the SMF 428 with the PDU Session Modification Complete message.

In the operation 405, the UE 422's application sends data packets to the remote end (e.g., the application server, the data network (DN)).

In the operation 406, the sequence of messages 406a/406b/406c may be repeated when there is an FRR change.

At the sub-operation 406a, the UPF 430's control program revises shaping characteristics for the flow due to policy or other utilization level changes. The UPF 430's control program informs the UPF 430's FRR module of the new information (i.e., new bandwidth).

At the sub-operation 406b, the UPF 430 sends PFCP Report Response containing and FRR notification with the new FRR information to the SMF 428.

At the sub-operation 406c, the SMF 428 associates the PFCP report message to the UE/PDU session and triggers a PDU Session Modification Command containing a TMM: FRR message with IP flow (5-tuple) and new bandwidth information.

In the operation 407, the 3GPP modules and the OS services in the UE 422 notify the application/network services of the new bandwidth. When the UE 422's application is notified, it is responsible for controlling the rate based on the new information. If the application in the UE 422 relies on the UE 422's network services for congestion and rate control, these services factor the new bandwidth in feedback information to manage sending rate.

In the operation 408, when the application in the UE 422 terminates, the socket extensions or other FRR support is released.

In the operation 409, the release of FRR support in the operation 408 results in the following sub-operations.

At the sub-operation 409a, the UE 422 sends a PDU Session Modification Request with TMM: FRR message to unsubscribe.

At the sub-operation 409b, the SMF 428 validates that the FRR request to unsubscribe is permitted.

At the sub-operation 409c, the SMF 428 sends an NF/PFCP Report Request to the UPF 430 with FRR unsubscribe.

At the sub-operation 409d, the UPF 430 removes the FRR rules and configuration pertaining to the flow.

At the sub-operation 409e, the UPF 430 sends the N4/PFCP Report Response to the SMF 428 acknowledging the removal of FRR.

At the sub-operation 409f, SMF 428 sends the PDU Session Modification Command acknowledging the removal of FRR. The UE 422 responds to the SMF 428 with the PDU Session Modification Complete message.

### Implementation of User Plane Based TMM Transport Channel by Using Dedicated QoS Flow

TMM transport in this implementation uses a separate QoS flow, which may be referred to as the TMM QoS flow. The TMM QoS flow is different than the user data QoS flow(s) that it helps to manage. Over the Uu interface, the data radio bearer (DRB) configured for the TMM QoS flow may be same as or different than the DRB configured for the associated user data QoS flow(s).

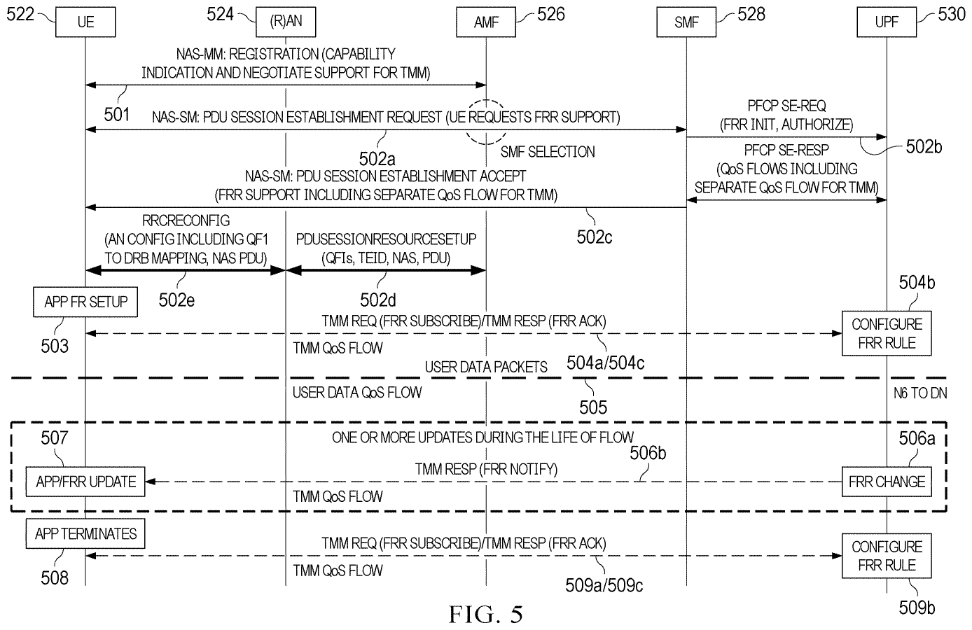

The sequence of operations to set up a TMM channel and FRR using the QoS Flow is shown in FIG. 5, in accordance with some implementations.

In the operation, 501, the UE 522 registers with the AMF 526 as described in TS 23.502, 4.2.2 (TS 24.501, 5.5 GMM procedures). The UE 422 indicates that it is capable of supporting TMM (and FRR), and the AMF 526 acknowledges the TMM support.

In the operation 502, at the sub-operation 502a, the UE 522 initiates the PDU session establishment using procedures described in TS 23.502, 4.3 (TS 24.501, section 6 5GSM procedures), and the AMF 526 selects the SMF 528 that is TMM-capable.

At the sub-operation 502b, the SMF 528 selects a TMM/FRR-capable UPF 530 to serve the PDU session and sends an N4/PFCP Session Establishment Request (SE-Req) to set up the PDU Session with separate QoS flows for the TMM QoS flow and the associated user data QoS flow(s). The SMF 528 also delegates FRR authorization rules to the UPF 430, which allows the UPF 430 to accept/reject FRR requests from the UE.

The UPF 430 responds with the N4/PFCP Session Establishment Response (SE-Resp) with the QoS Flow identifier (ID) of the TMM QoS flow and the QoS flow identifier(s) (QFI(s)) of the associated user data QoS flow along with GTP tunnel endpoint identifier (TEID) and other parameters of the PDU session.

At the sub-operation 502c, the SMF 528 sends the PDU session establishment accept message, including information of the separates QoS flows, to the UE 522.

At the sub-operation 502d, the SMF 528 provides information (such as QoS profiles) of the TMM QoS flow and the user data QoS flow(s) to the gNB and requests the gNB 524 to set up radio resources to meet the QoS requirements for them.

At the sub-operation 502e, the gNB 524 configures one or more DRBs to serve the QoS flows that the SMF 528 has requested via an RRC reconfiguration procedure and provides the QFI to DRB mapping rule to the UE 522. In one example, the gNB 524 configures a single DRB to map to both the TMM QoS flow and the associated user data QoS flow. In this example, the gNB 524 also configures the SDAP entity to add an SDAP header to all SDAP data PDUs so that the QFI field in the SDAP header allows the receiver to differentiate which received SDAP SDUs belong to the TMM QoS flow and which belong to the user data QoS flow so that the receiving SDAP entity can forward the received SDAP SDUs accordingly. In another example, the gNB 524 configures a unique DRB for each of the TMM QoS flow and the associated user data QoS flow(s). In this example, the gNB 524 configures the SDAP entity not to add SDAP header to any SDAP data PDU of the PDU session because the one-to-one mapping relationship and configured QFI to DRB mapping rules already allow the receiver to differentiate which received SDAP SDUs belong to the TMM QoS flow and which ones belong to the user data QoS flow based on over which DRB they are respectively received.

In the operation 503, the application in the UE 522 starts.

At the sub-operation 503a, if the application in the UE 522 is FRR aware (e.g., video streaming with ABR), the application requests the FRR support from underlying OS services.

At the sub-operation 503b, if the application in the UE 522 relies on UE 522's OS networking for congestion control (or above kernel service as in QUIC), the application in the UE 522 requests FRR using socket extensions.

In the operation 504, at the sub-operation 504a, the UE 522's application's request for FRR in the previous operation 503 results in the FRR entity in the UE initiating an FRR subscribe message, and the TMM entity in the UE 522 encapsulates the FRR request in a first TMM message. The 3GPP module in the UE 522 sends the TMM request over the TMM QoS flow to the UPF 530.

The UPF 530 validates the FRR subscription request to ensure that the UE 522 is allowed to request for capabilities for this IP flow.

At the sub-operation 504b, the UPF 530 initializes the control program (see FIG. 2) to report bandwidth changes to the FRR entity, which generates the FRR to be sent back to the FRR entity in the UE 522.

At the sub-operation 504c, the FRR acknowledge message is encapsulated in a second TMM message, and the second TMM message is sent over the TMM QOS flow to the UE 522.

In the operation 505, the UE 522's application sends data packets to the remote end (e.g., the application server, DN).

In the operation 506, at the sub-operation 506a, the UPF 530's control program revises shaping characteristics for the flow due to policy or other utilization level changes. The control program in the UPF 530 informs the FRR entity in the UPF 530 of the new information (i.e., new bandwidth).

At the sub-operation 506b, the FRR entity in the UPF 530 triggers a TMM Notification message with the IP flow (e.g., 5-tuple) and new bandwidth information in another FRR notify message. The TMM Response message with the FRR information (in an FRR notify message) is sent over the TMM QoS flow to the UE 522.

In the operation 507, the 3GPP modules and OS services in the UE 522 notify the application/network services in the UE 522 of the new bandwidth. When the application in the UE 522 is notified, it is responsible for controlling the rate based on the new information. If the application in the UE 522 relies on the UE 522's network services for congestion and rate control, these services factor the new bandwidth in feedback information to manage the sending rate.

In the operation 508, when the application in the UE 522 terminates, the socket extensions or other FRR support is released.

In the operation 509, the release of FRR support in the operation 508 results in the following sub-operations.

At the sub-operation 509a, the UE 522 sends a PDU Session Modification Request with TMM: FRR message to unsubscribe.

At the sub-operation 509b, the SMF 528 validates that the FRR request to unsubscribe is permitted.

At the sub-operation 509c, the SMF 528 sends an NF/PFCP Report Request to UPF 530 with FRR unsubscribe.

At the sub-operation 509d, the UPF 530 removes FRR rules and configuration pertaining to the flow.

At the sub-operation 509e, the UPF 530 sends the N4/PFCP Report Response to the SMF 528 acknowledging the removal of FRR.

At the sub-operation 509f, the SMF 528 sends the PDU Session Modification Command acknowledging the removal of FRR. The UE 522 responds to the SMF 528 with PDU Session Modification Complete message.

### Another Example Implementation of User Plane Based TMM Transport Channel Involving the Use of SDAP Control PDU

TMM transport in this implementation uses an SDAP control PDU to carry the TMM message over the Uu interface (i.e., between the UE and the gNB) and uses a new GTP-U extension to carry the TMM message over the N3 interface (i.e., between the gNB and the UPF). The SDAP control PDU may be referred to as the SDAP TMM transfer control PDU. The GTP-U extension may be new but similar to what has been defined for carrying the PDU Set Information over the N3 interface for the XR video packets.

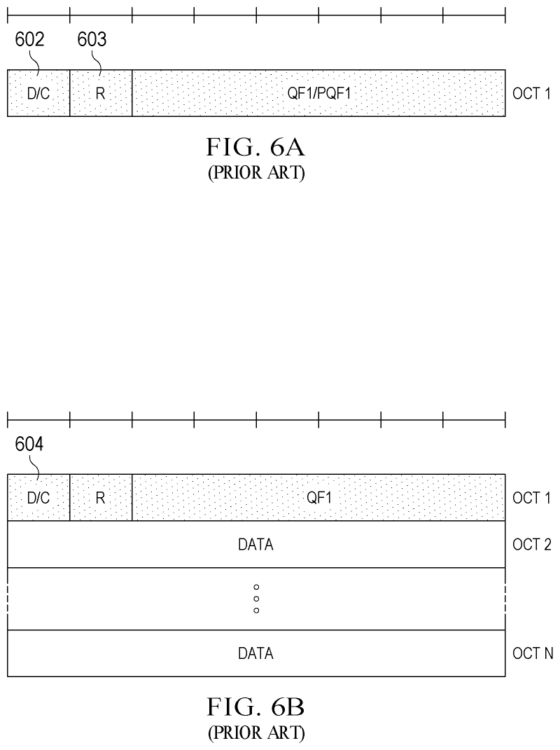

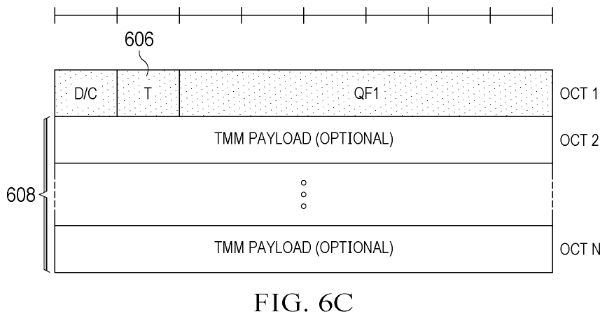

In this implementation, the SDAP entity is configured to add an SDAP header for every SDAP PDU so that the Data/Control (D/C) field in the header can be used for differentiating the SDAP Control PDUs from SDAP data PDUs. Currently, the D/C field is in the UL SDAP End-Marker control PDU and the UL SDAP data PDU, the formats of which are shown in FIGS. 6A and 6B, respectively. A value “0” in the D/C field 602 indicates that the SDAP PDU is a SDAP control PDU, and a value “1” in the D/C field 604 indicates that the SDAP PDU is a SDAP data PDU.

To introduce the SDAP TMM transfer control PDU, a new format for the SDAP control PDU is introduced, as shown in FIG. 6C. The bit between the D/C field and QFI field may be defined as a control PDU Type (T) field 606. A value “1” in the T field 606 indicates that the SDAP control PDU is a SDAP TMM Transfer control PDU for both UL and DL. A value “0” in the T field 606 is reserved for the DL and, for the UL, indicates that the SDAP control PDU is a SDAP End-Marker control PDU, so that it is backward-compatible with the format of the existing SDAP End-Marker control PDU on the UL, because the R (for “Reserved”) field 603 in the existing format of SDAP End-Marker control PDU, as shown in FIG. 6A, is set to value “0”. The TMM Payload field 608 is present in the SDAP control PDU when the T field is set to “1” and otherwise it is absent.

The existing format for the DL SDAP data PDUs is incompatible with the new DL SDAP control PDU because all bits in existing DL SDAP data PDU header are used for indicating information related to reflective QoS mapping, and hence there is no D/C field in the header to differentiate between SDAP data PDUs and SDAP control PDUs. To support TMM transfer in the DL, the DL SDAP data PDUs also use the format as shown in FIG. 6B. Therefore, in this implementation, a QoS flow cannot support TMM and reflective QoS mapping simultaneously.

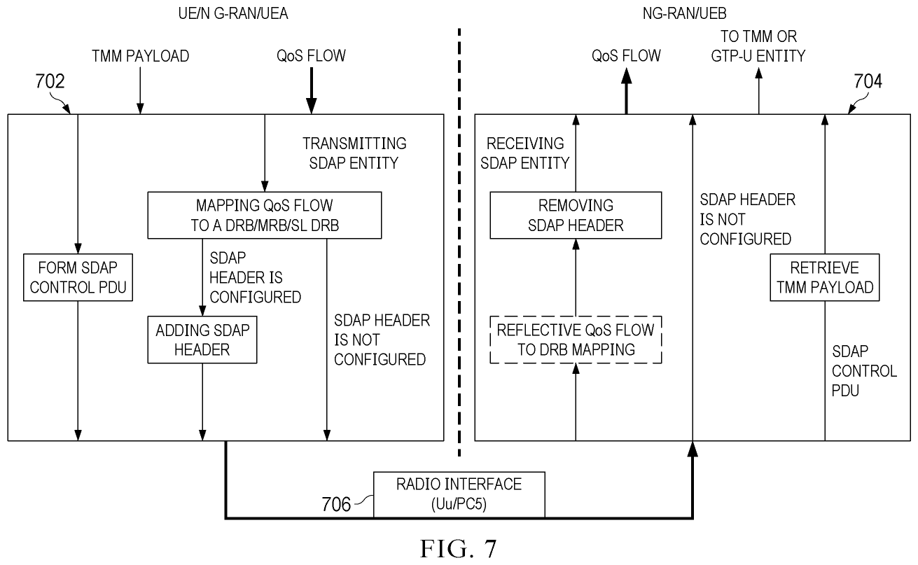

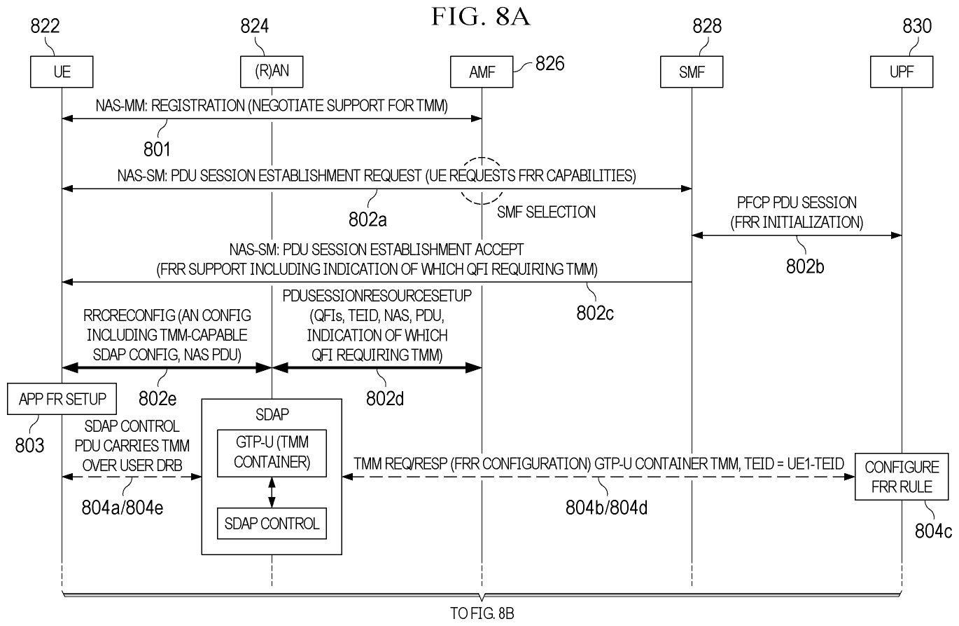

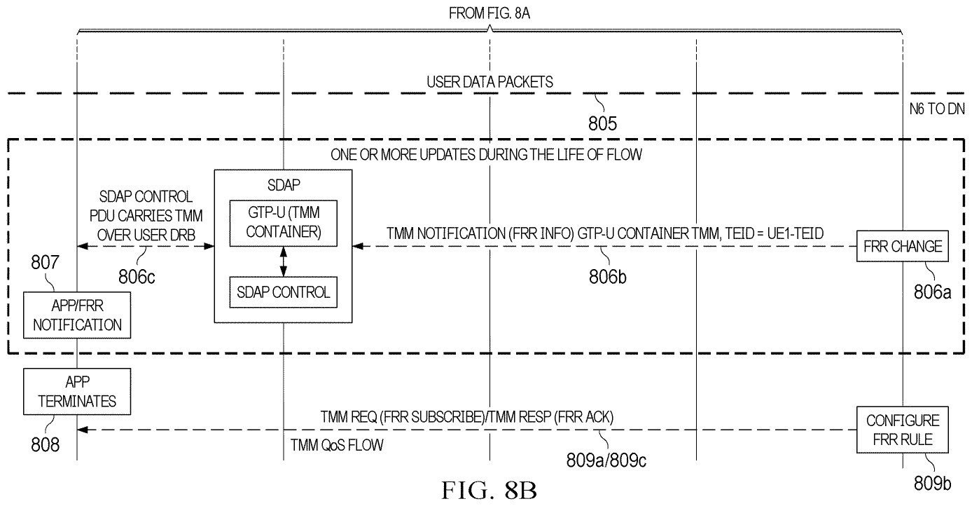

FIG. 7 illustrates the functional view of the enhanced transmitting SDAP entity 702 (shown on the left) and receiving SDAP entity 704 (shown on the right) to support the transfer of TMM messages over the Uu (e.g., between the UE and the gNB) or PC5 (e.g., between two UEs) interface 706, in accordance with some implementations. In the transmitting SDAP entity 702, the TMM payload (e.g., as retrieved by the gNB (which is also referred to as NG-RAN node) from the GTP-U ext. header of a GTP-U packet received from the UPF (for the DL) or as provided by the higher layer entity in the UE (for the UL)) may be encapsulated in an SDAP control PDU (e.g., the SDAP TMM Transfer control PDU as described above) sent towards the receiving SDAP entity 704 in the UE (for DL) or in the gNB (for the UL). In the receiving SDAP entity 704, the TMM payload in the SDAP control PDU is retrieved and forwarded to the TMM entity in the UE for further processing for the DL, or for the UL, to the GTP-U entity in the gNB to be further conveyed to the UPF via the GTP-U extension header with TEID that is set up during the PDU session/TMM channel setup (see FIGS. 8A-8B as described below).

The sequence of operations to set up a TMM transport over a TMM RB and TMM GTP-U Extension is shown in FIGS. 8A-8B, in accordance with some implementations.

In the operation 801, the UE 822 registers with the AMF 826 as described in TS 23.502, 4.2.2 (TS 24.501, 5.5 GMM procedures). The UE 522 requests support for TMM, and the AMF 826 acknowledges the TMM support.

In the operation 802, at the sub-operation 802a, the UE 822 initiates PDU session establishment using procedures described in TS 23.502, 4.3 (TS 24.501, section 6 5GSM procedures), and the AMF 826 selects the SMF 828 that is TMM capable.

At the sub-operation 802b, the SMF 828 selects the UPF 830 that can support QoS flow based TMM and sends an N4/PFCP request to set up QoS flows for both user data transport and the TMM channel.

The UPF 830 responds with the QoS Flow for user data transport and acknowledges TMM channel along with GTP TEID.

At the sub-operation 802c, the SMF 826 sends PDU session establishment accept message to the UE 822 with FFR support including indication of which QFI is for TMM.

At the sub-operation 802d, the SMF 826 requests the (R)AN 824 to set up the SDAP control PDU for TMM channel in the GTP-U extension with TEID and indication of which QFI is for TMM.

At the sub-operation 802e, RRC reconfiguration procedures including TMM-capable SDAP configuration are performed.

In the operation 803, the application in the UE starts.

If the application is FRR aware (e.g., video streaming with ABR), the application requests FRR support from underlying OS services.

If the application relies on OS networking for congestion control (or above kernel service as in QUIC), the application requests FRR using socket extensions.

The application's request for FRR may results in initiating the FRR setup in the UE 822's 3GPP module.

In the operation 804, at the sub-operation 804a/804e, the UE 822 sends a user plane TMM request with FRR configuration that includes IP flow (5-tuple) and FRR report requested (i.e., bandwidth change) over and the SDAP control PDU to (R)AN 824 where it is mapped to GTP-U extension/TEID for delivery to the UPF 830.

At the sub-operation 804c, the UPF 830 configures the FRR rule.

At the sub-operation 804b/804d, the UPF 830 validates the FRR request to ensure that the UE 822 is allowed to request for capabilities for this IP flow.

The UPF 830 initializes the control program (see FIG. 2) to report bandwidth changes to FRR module in the UPF 830. The UPF 830 responds with denoting setup of the FRR for the flow.

In the operation 805, the UE 822's application sends data packets to remote end (e.g., the application server, the DN).

In the operation 806, at the sub-operation 806a, the UPF 830's control program revises shaping characteristics for the flow due to policy or other utilization level changes. The control program in the UPF 830 informs the FRR module in the UPF 830 of the new information (i.e., new bandwidth) which in turn triggers a user plane TMM message with the FRR information.

At the sub-operation 806b, the FRR module in the UPF 830 triggers a user plane TMM notification message with the IP flow (5-tuple) and the new bandwidth information in FRR to be sent to the gNB 824 using the GTP-U extension with TMM/FRR. The TMM notification message is inserted in the SDAP control PDU at the gNB 824 for delivery to the UE 822.

In the operation 807, the 3GPP modules and OS services in the UE 822 notify the application/network services in the UE 822 of the new bandwidth. When the application is notified, it is responsible for controlling the rate based on the new information. If the application relies on the UE 822's network services for congestion and rate control, these services factor the new bandwidth in feedback information to manage the sending rate.

In the operation 808, when the application in the UE 822 terminates, the socket extensions or other FRR support is released.

In the operation 809, the release of FRR support in the operation 808 results in the following sub-operations.

At the sub-operations 809a, the UE 822 sends a PDU Session Modification Request with TMM: FRR message to unsubscribe.

At the sub-operation 809b, the SMF 828 validates that the FRR request to unsubscribe is permitted.

At the sub-operation 809c, the SMF 828 sends an NF/PFCP Report Request to the UPF 830 with FRR unsubscribe.

At the sub-operation 809d, the UPF 830 removes FRR rules and configuration pertaining to the flow.

At the sub-operation 809e, the UPF 830 sends the N4/PFCP Report Response to the SMF 828 acknowledging the removal of FRR.

At the sub-operation 809f, the SMF 828 sends the PDU Session Modification Command acknowledging the removal of FRR. The UE 822 responds to the SMF 828 with the PDU Session Modification Complete message.

### Yet Additional Example Implementations of User Plane Based TMM Transport Channel Involving the Use of PDCP Control PDU

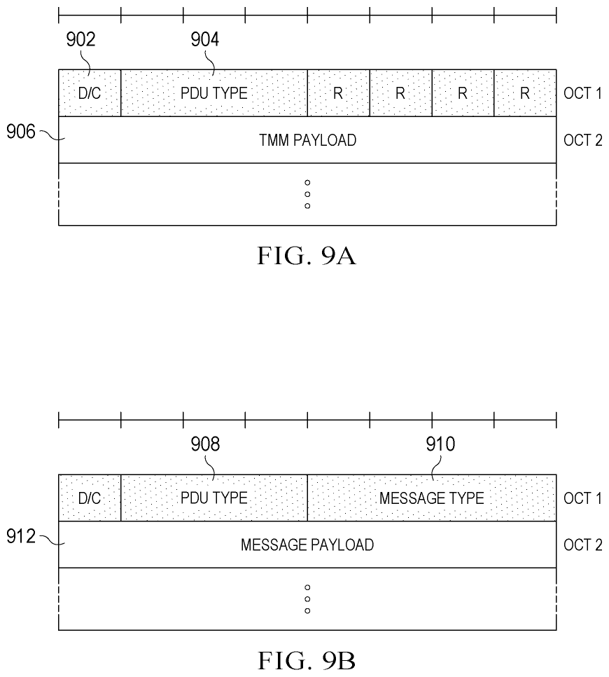

In a first example implementation, a new type of PDCP control PDU is introduced, (e.g., referred to as the TMM transfer control PDU), with a format shown in FIG. 9A, where the D/C field 902 is set to value “0” to indicate that the PDCP PDU is a PDCP control PDU. When the D/C field 902 is set to value “0”, the PDU Type field 904 indicates the type of the control PDU, as shown in Table 1 below. When the PDU Type field 904 is set to value “101,” the PDCP control PDU is the PDCP TMM transfer control PDU and the TMM payload field 906 carries the TMM message.

TABLE 1
PDU Type field values (for the first embodiment)

| Bit | Description of type of PDCP control PDU |
|---|---|
| 000 | PDCP status report |
| 001 | Interspersed ROHC feedback |
| 010 | EHC feedback |
| 011 | UDC feedback |
| 100 | PDCP SN gap report |
| 101 | TMM transfer |
| 110-111 | Reserved |

In an alternative example implementation, the new type of PDCP control PDU introduced may be referred to as the Generic Message Transfer control PDU, with a format shown in FIG. 9B and the PDU type field 908 as defined in Table 2 below, where the remaining 4 bits of the first octets is used as a Message Type field 910 to indicate the type of the message being carried in the Message Payload field 912 in the PDCP control PDU. For example, the Message Type field 910 may be set to value “0000” when the Message Payload field 912 carries a TMM Request message, to value “0001” when the Message Payload field 912 carries a TMM Response message, and to value “0010” when the Message Payload field 912 carries a TMM Notification message, with other values reserved or used for other purposes. For another example, the Message Type field 910 may be set to value “0000” when the Message Payload field 912 carries a TMM message, to value “0001” when the Message Payload field 912 carries the PDU Set Information for XR traffic, to value “0010” when the Message Payload field 912 carries artificial intelligence/machine learning (AI/ML) control message, with other values reserved or used for other purposes. In this implementation, the receiving PDCP entity uses the Message Type value in the header to route the retrieved message payload to the corresponding higher layer entity, such as the TMM entity, the XR entity, the AI/ML entity, etc.

TABLE 2
PDU Type field values (for the second embodiment)

| Bit | Description of type of PDCP control PDU |
|---|---|
| 000 | PDCP status report |
| 001 | Interspersed ROHC feedback |
| 010 | EHC feedback |
| 011 | UDC feedback |
| 100 | PDCP SN gap report |
| 101 | Generic Message Transfer |
| 110-111 | Reserved |

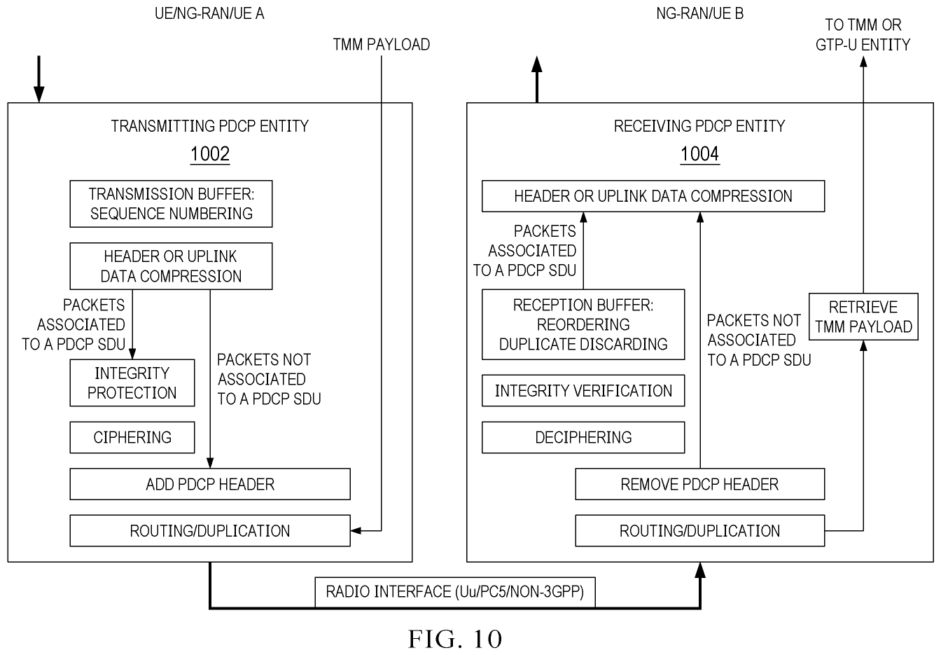

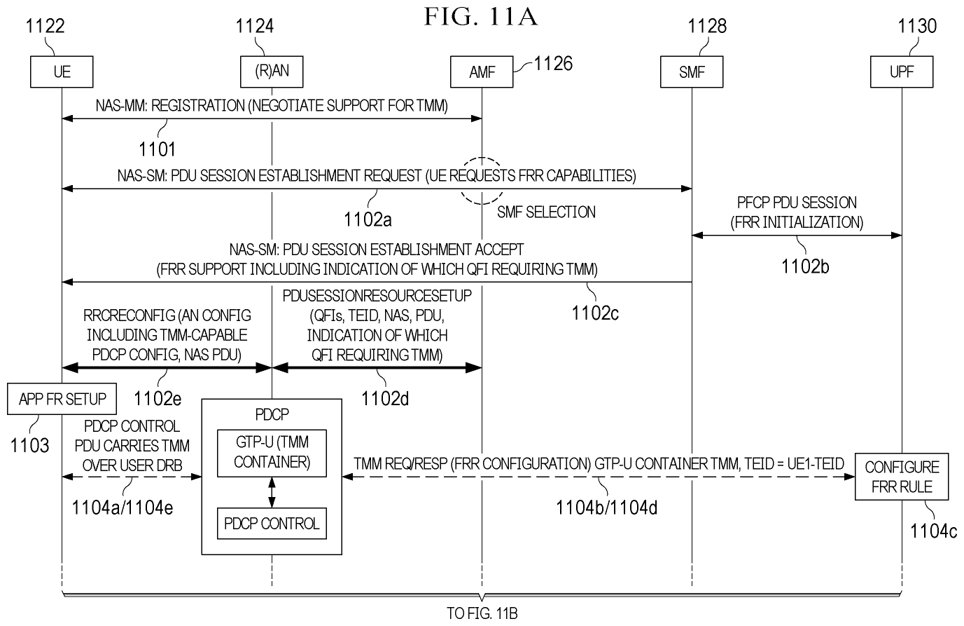

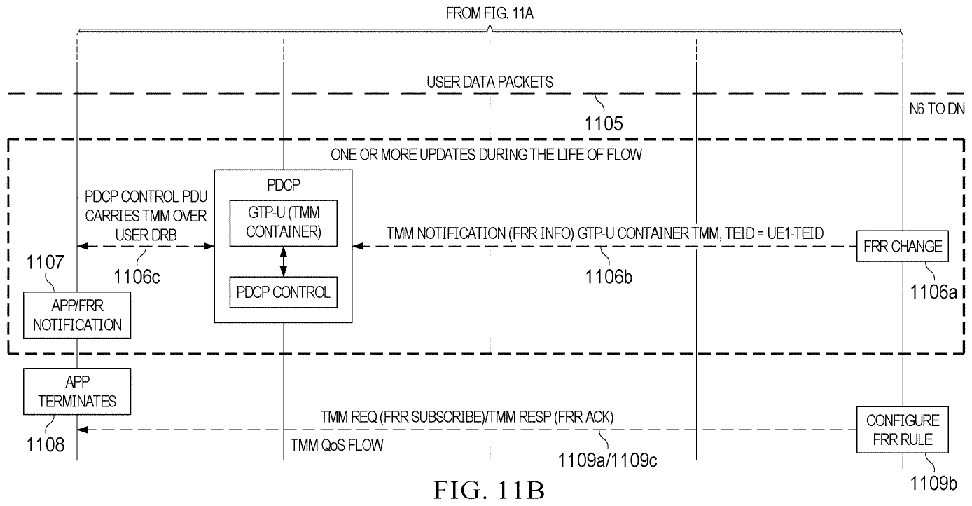

FIG. 10 illustrates the functional view of the enhanced transmitting PDCP entity 1002 (shown on the left) and receiving PDCP entity 1004 (shown on the right) to support the transfer of TMM messages over the Uu interface (e.g., between the UE and the gNB). In the transmitting PDCP entity 1002, the TMM payload (e.g., as retrieved by the gNB from the GTP-U extension header of a GTP-U packet received from the UPF (for the DL) or as provided by the higher layer entity in the UE (for the UL) is encapsulated in the new PDCP control PDU (e.g., the PDCP TMM Transfer control PDU as described above), which is sent towards the receiving PDCP entity 1004 in the UE (for DL) or in the gNB (for the UL)). In the receiving PDCP entity 1004, the TMM payload in PDCP control PDU is retrieved and forwarded to the TMM entity in the UE for further processing for the DL, or for the UL, to the GTP-U entity in the gNB to be further conveyed to the UPF via the GTP-U extension header with TEID that is setup during the PDU session/TMM channel setup (see FIGS. 11A-11B described below).

The sequence of operations to set up a TMM transport over a TMM resource block (RB) and TMM GTP-U extension is shown in FIGS. 11A-11B, in accordance with some implementations.

In the operation 1101, the UE 1122 registers with the AMF 1126 as described in TS 23.502, 4.2.2 (TS 24.501, 5.5 GMM procedures). The UE 1122 requests support for TMM and the AMF 1126 acknowledges the TMM support.

In the operation 1102, at the sub-operation 1102a, the UE 1122 initiates PDU session establishment using procedures described in TS 23.502, 4.3 (TS 24.501, section 6 5GSM procedures), and the AMF 1126 selects the SMF 1128 that is TMM capable.

At the sub-operation 1102b, the SMF selects the UPF 1130 that can support QoS flow based TMM and sends an N4/PFCP request to set up QoS flows for both user data transport and TMM channel.

The UPF 1130 responds with the QoS flow for user data transport and acknowledges TMM channel along with GTP TEID.

At the sub-operation 1102c, the SMF 1128 sends the PDU session establishment accept message to the UE 1122 with FFR support including indication of which QFI for TMM.

At the sub-operation 1102d, the SMF 1128 requests the (R)AN 1124 to set up the SDAP control PDU for TMM channel in the GTP-U extension with the TEID and indication of which QFI for TMM.

At the sub-operation 1102e, RRC reconfiguration procedures including TMM-capable SDAP configuration are performed.

In the operation 1103, the application in the UE 1102 starts.

If the application in the UE 1102 is FRR aware (e.g., video streaming with ABR), the application requests FRR support from underlying OS services in the UE 1102.

If the application in the UE 1102 relies on OS networking in the UE 1102 for congestion control (or above kernel service as in QUIC), the application requests FRR using socket extensions.

The application's request for FRR results in initiating FRR setup in the UE 1122's 3GPP module.

In the operation 1104, at the sub-operation 1104a/1104e, the UE 1122 sends a user plane TMM request with the FRR configuration that includes IP flow (5-tuple) and the FRR report requested (e.g., bandwidth change) over and the PDCP control PDU to the (R)AN 1124 where it is mapped to GTP-U extension/TEID for delivery to the UPF 1130.

At the sub-operation 1104c, the UPF 1130 configures the FRR rule.

At the sub-operation 1104b/1104d, the UPF 1130 validates the FRR request to ensure that the UE 1122 is allowed to request for capabilities for this IP flow.

The UPF 1130 initializes the control program (see FIG. 2) to report bandwidth changes to the FRR module in the UPF 1130.

The UPF 1130 responds denoting setup of the FRR for the flow.

In the operation 1105, the UE 1122's application sends data packets to the remote end (e.g., the application server, the DN).

In the operation 1106, at the sub-operation 1106a, the UPF 1130's control program revises shaping characteristics for the flow due to policy or other utilization level changes. The control program informs FRR module in the UFP 1130 of the new information (i.e., new bandwidth), which in turn triggers a user plane TMM message with FRR information.

At the sub-operation 1106b, the FRR module in the UPF 1130 triggers a user plane TMM Notification message with IP flow (5-tuple) and new bandwidth information in FRR to be sent to the gNB 1124 using the GTP-U extension with TMM/FRR.

At the sub-operation 1106c, the TMM Notification message is inserted in the PDCP control PDU at the gNB 1124 for delivery to the UE 1122.

In the operation 1107, the 3GPP modules and OS services in the UE 1122 notify the application/network services in the UE 1122 of the new bandwidth. When the application is notified, it is responsible for controlling the rate based on the new information. If the application in the UE 1122 relies on the UE 1122's network services for congestion and rate control, these services factor the new bandwidth in feedback information to manage sending rate.

In the operation 1108, when the application in the UE 1122 terminates, the socket extensions or other FRR support is released.

In the operation 1109, the release of FRR support in the operation 1108 results in the following sub-operations.

At the sub-operation 1109a, the UE 1122 sends a PDU Session Modification Request with TMM: FRR message to unsubscribe.

At the sub-operation 1109b, the SMF 1128 validates that the FRR request to unsubscribe is permitted.

At the sub-operation 1109c, the SMF 1128 sends an NF/PFCP Report Request to the UPF 1130 with FRR unsubscribe.

At the sub-operation 1109d, the UPF 1130 removes FRR rules and configuration pertaining to the flow.

At the sub-operation 1109e, the UPF 1130 sends an N4/PFCP Report Response to the SMF 1128 acknowledging the removal of FRR.

At the sub-operation 1109f, the SMF 1128 sends the PDU Session Modification Command acknowledging the removal of FRR. The UE 1122 responds to the SMF 1128 with the PDU Session Modification Complete message.

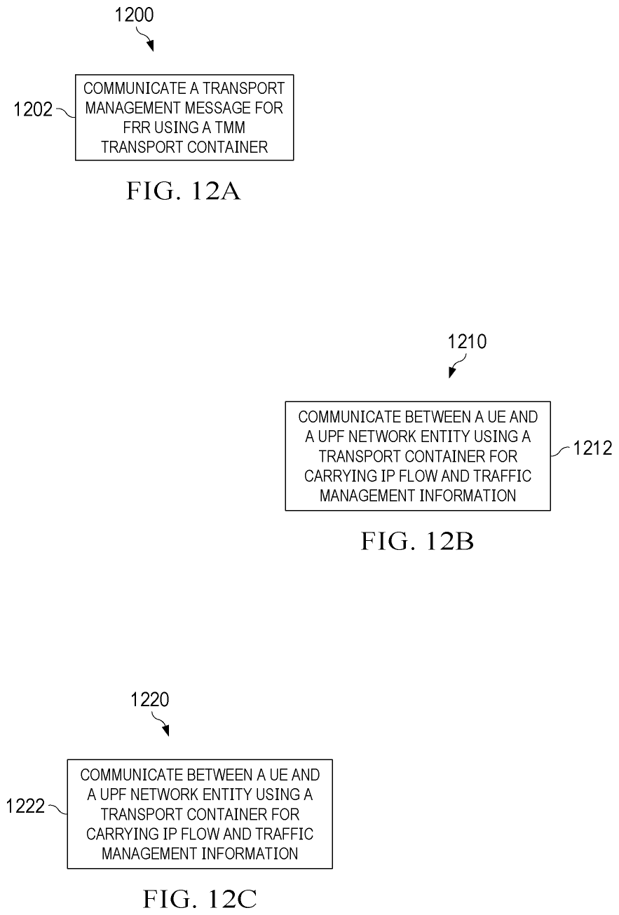

FIG. 12A shows a flow chart of a method 1200 performed by a communication device, according to some implementations. The communication device may include computer-readable code or instructions executing on one or more processors of the communication device. Coding of the software for carrying out or performing the method 1200 is well within the scope of a person of ordinary skill in the art having regard to the present disclosure. The method 1200 may include additional or fewer operations than those shown and described and may be carried out or performed in a different order. Computer-readable code or instructions of the software executable by the one or more processors may be stored on a non-transitory computer-readable medium, such as for example, the memory of the communication device. In some implementations, the method 1200 may be performed by one or more of units or modules (e.g., an integrated circuit) of the communication device, such as field programmable gate arrays (FPGAs) or application-specific integrated circuits (ASICs).

At the operation 1202 of the method 1200, the communication device communicates a transport management message for flow regulation report (FRR) using a traffic management and monitoring (TMM) transport container based on extensions to a third generation partnership project (3GPP) control plane channel or a 3GPP user plane channel. A user plane function (UPF) network entity provides a user equipment (UE) with bandwidth or other flow conditions between the UPF network entity and the UE.

In accordance with some implementations, the communication device may be one of the UPF network entity or the UE.

In accordance with some implementations, the transport management message may include a command to the UPF network entity for an end-to-end (E2E) internet protocol (IP) flow that belongs to a protocol data unit (PDU) session of the UE.

In accordance with some implementations, a session management function (SMF) network entity may authorize a flow regulation request message for the FRR based on policies or ownership of the E2E IP flow that belongs to the PDU session of the UE.

In accordance with some implementations, an SMF network entity may delegate authorization of a flow regulation request message for the FRR to the UPF network entity based on policies or ownership of the E2E IP flow that belongs to the PDU session of the UE.

In accordance with some implementations, the transport management message for the FRR may indicate a change in bandwidth constraints for the E2E IP flow.

In accordance with some implementations, the communication device may be the UE. An application in the UE may be eligible to requesting a change in flow regulation. When the application starts, the application in the UE may initiate setup of the FRR in the UE to request the change in the flow regulation attributes from a network device attributes.

In accordance with some implementations, the application in the UE may determine eligibility of the application to request for the change in the flow regulation attributes from the network device based on UE route selection policies (URSP).

In accordance with some implementations, the UE may determine the application corresponding to the transport management message for the FRR based on IP flow information, the IP flow information including a 5-tuple of an E2P IP flow.

In accordance with some implementations, the communication device may be the UPF network entity. The UPF network entity may configure the FRR that instructs a control program of the UPF network entity to change E2E flow shaping or scheduling attributes. The UPF network entity may send or receive the transport management message for the FRR.

In accordance with some implementations, the TMM transport container may use non-access stratum (NAS) message extensions between the UE and an SMF network entity and use packet forwarding control protocol (PFCP) extensions between the SMF network entity and the UPF network entity.

In accordance with some implementations, the TMM transport container may be in one of (i) a dedicated quality of service (QoS) flow, (ii) a service data adaption protocol (SDAP) control channel, or (iii) a packet data convergence protocol (PDCP) control protocol data unit (PDU).

In accordance with some implementations, the TMM transport container may be carried in the dedicated QoS flow separate from user data QoS flows.

In accordance with some implementations, the dedicated QoS flow and the user data QoS flows may be mapped to a single data radio bearer (DRB).

In accordance with some implementations, the dedicated QoS flow and user data QoS flows may be mapped to separate data radio bearers DRBs.

In accordance with some implementations, the TMM transport container may be carried in an SDAP control PDU. The SDAP control PDU may include a control PDU type field indicating that the SDAP control PDU is an SDAP TMM Transfer control PDU.

In accordance with some implementations, the TMM transport container may be carried in the PDCP control PDU. The PDCP control PDU may include a PDU type field indicating that the PDCP control PDU is a TMM transfer control PDU. Or, the PDCP control PDU may be a generic message transfer control PDU that includes a message type field indicating that a message type is carried in a message payload field.

In accordance with some implementations, the bandwidth or other flow conditions may be carried in the TMM transport container. The UPF network entity may provide the TMM transport container to the UE such that the UPF network entity provides the TMM transport container directly to the UE without any other network entity relaying the TMM transport container or the UPF network entity provides the TMM transport container to the UE via a second network entity without the TMM transport container being modified by the second network entity.

In accordance with some implementations, the second network entity may be an SMF network entity.

In accordance with some implementations, the extensions to the 3GPP control plane channel or the 3GPP user plane may be implemented at a layer lower than an IP layer.

FIG. 12B shows a flow chart of a method 1210 performed by a communication device, according to some implementations. The communication device may include computer-readable code or instructions executing on one or more processors of the communication device. Coding of the software for carrying out or performing the method 1210 is well within the scope of a person of ordinary skill in the art having regard to the present disclosure. The method 1210 may include additional or fewer operations than those shown and described and may be carried out or performed in a different order. Computer-readable code or instructions of the software executable by the one or more processors may be stored on a non-transitory computer-readable medium, such as for example, the memory of the communication device. In some implementations, the method 1210 may be performed by one or more of units or modules (e.g., an integrated circuit) of the communication device, such as field programmable gate arrays (FPGAs) or application-specific integrated circuits (ASICs).

At the operation 1212 of the method 1210, the communication device communicates between a user equipment (UE) and a user plane function (UPF) network entity using a transport container for carrying internet protocol (IP) flow and traffic management information. The transport container uses non-access stratum (NAS) message extensions between the UE and a session management function (SMF) network entity and uses packet forwarding control protocol (PFCP) extensions between the SMF network entity and the UPF network entity.

In accordance with some implementations, the communication device may be one of the UPF network entity or the UE.

FIG. 12C shows a flow chart of a method 1220 performed by a communication device, according to some implementations. The communication device may include computer-readable code or instructions executing on one or more processors of the communication device. Coding of the software for carrying out or performing the method 1220 is well within the scope of a person of ordinary skill in the art having regard to the present disclosure. The method 1220 may include additional or fewer operations than those shown and described and may be carried out or performed in a different order. Computer-readable code or instructions of the software executable by the one or more processors may be stored on a non-transitory computer-readable medium, such as for example, the memory of the communication device. In some implementations, the method 1220 may be performed by one or more of units or modules (e.g., an integrated circuit) of the communication device, such as field programmable gate arrays (FPGAs) or application-specific integrated circuits (ASICs).

At the operation 1222 of the method 1220, the communication device communicates between a user equipment (UE) and a user plane function (UPF) network entity using a transport container for carrying internet protocol (IP) flow and traffic management information. The transport container is in one of (i) a dedicated quality of service (QoS) flow, (ii) a service data adaption protocol (SDAP) control channel, or (iii) a packet data convergence protocol (PDCP) control protocol data unit (PDU).

In accordance with some implementations, the communication device may be one of the UPF network entity or the UE.

The following references are incorporated by reference in this disclosure.
3GPP TS 23.501: System Architecture for the 5G System (5GS) https://www.3gpp.org/ftp/Specs/archive/23_series/23.501/23501-i22.zip
3GPP TS 23.502 Procedures for the 5G System (5GS) https://www.3gpp.org/ftp/Specs/archive/23_series/23.502/23502-i20.zip
3GPP SP-231198 Study on Architecture Enhancement for XRM Ph 2
3GPP TS 29.281 General Packet Radio System (GPRS) Tunneling Protocol User Plane (GTPv1-U). https://www.3gpp.org/ftp/Specs/archive/29_series/29.281/29281-h40.zip
3GPP TS 24.501: Non-Access Stratum Protocols for 5G System (5GS), Stage 3. https://www.3gpp.org/ftp/Specs/archive/24_series/24.501/24501-i40.zip
3GPP TS 38.413 NG-RAN; NG Application Protocol (NGAP) https://www.3gpp.org/ftp/Specs/archive/38_series/38.413/38413-i10.zip
SA2 Rel-19 23Q4 moderated discussion—Traffic Management/Monitoring—Version 0.0.1 https://nwm-trial.etsi.org/#/documents/8671
IETF draft, “Requirements for Network Collaboration signaling”, https://datatracker.ietf.org/doc/draft-kwbdgrr-tsvwg-net-collab-rqmts/

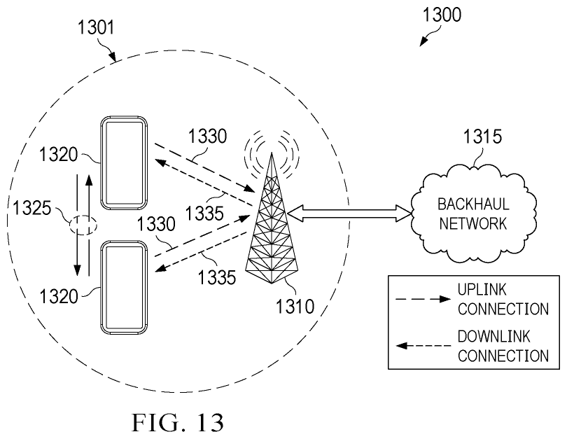

FIG. 13 illustrates an example communications system 1300. Communications system 1300 includes an access node 1310 serving user equipments (UEs) with coverage 1301, such as UEs 1320. In a first operating mode, communications to and from a UE passes through access node 1310 with a coverage area 1301. The access node 1310 is connected to a backhaul network 1315 for connecting to the internet, operations and management, and so forth. In a second operating mode, communications to and from a UE do not pass through access node 1310, however, access node 1310 typically allocates resources used by the UE to communicate when specific conditions are met. Communications between a pair of UEs 1320 can use a sidelink connection (shown as two separate one-way connections 1325). In FIG. 13, the sideline communication is occurring between two UEs operating inside of coverage area 1301. However, sidelink communications, in general, can occur when UEs 1320 are both outside coverage area 1301, both inside coverage area 1301, or one inside and the other outside coverage area 1301. Communication between a UE and access node pair occur over uni-directional communication links, where the communication links between the UE and the access node are referred to as uplinks 1330, and the communication links between the access node and UE is referred to as downlinks 1335.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

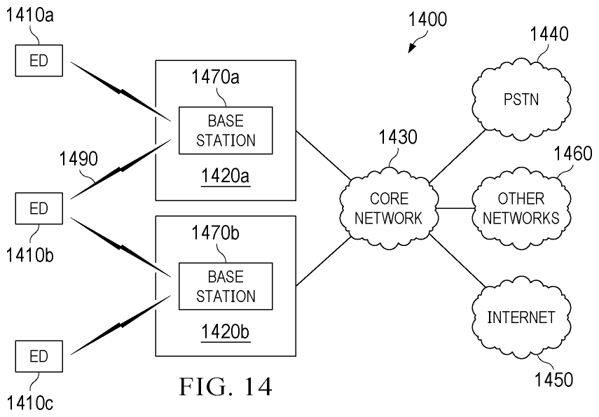

FIG. 14 illustrates an example communication system 1400. In general, the system 1400 enables multiple wireless or wired users to transmit and receive data and other content. The system 1400 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1400 includes electronic devices (ED) 1410a-1410c, radio access networks (RANs) 1420a-1420b, a core network 1430, a public switched telephone network (PSTN) 1440, the Internet 1450, and other networks 1460. While certain numbers of these components or elements are shown in FIG. 14, any number of these components or elements may be included in the system 1400.

The EDs 1410a-1410c are configured to operate or communicate in the system 1400. For example, the EDs 1410a-1410c are configured to transmit or receive via wireless or wired communication channels. Each ED 1410a-1410c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1420a-1420b here include base stations 1470a-1470b, respectively. Each base station 1470a-1470b is configured to wirelessly interface with one or more of the EDs 1410a-1410c to enable access to the core network 1430, the PSTN 1440, the Internet 1450, or the other networks 1460. For example, the base stations 1470a-1470b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 1410a-1410c are configured to interface and communicate with the Internet 1450 and may access the core network 1430, the PSTN 1440, or the other networks 1460.

In the embodiment shown in FIG. 14, the base station 1470a forms part of the RAN 1420a, which may include other base stations, elements, or devices. Also, the base station 1470b forms part of the RAN 1420b, which may include other base stations, elements, or devices. Each base station 1470a-1470b operates to transmit or receive wireless signals within a particular geographic region or area, sometimes referred to as a “cell.” In some embodiments, multiple-input multiple-output (MIMO) technology may be employed having multiple transceivers for each cell.

The base stations 1470a-1470b communicate with one or more of the EDs 1410a-1410c over one or more air interfaces 1490 using wireless communication links. The air interfaces 1490 may utilize any suitable radio access technology.

It is contemplated that the system 1400 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1420a-1420b are in communication with the core network 1430 to provide the EDs 1410a-1410c with voice, data, application, Voice over Internet Protocol (VoIP), or other services. Understandably, the RANs 1420a-1420b or the core network 1430 may be in direct or indirect communication with one or more other RANs (not shown). The core network 1430 may also serve as a gateway access for other networks (such as the PSTN 1440, the Internet 1450, and the other networks 1460). In addition, some or all of the EDs 1410a-1410c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1450.

Although FIG. 14 illustrates one example of a communication system, various changes may be made to FIG. 14. For example, the communication system 1400 could include any number of EDs, base stations, networks, or other components in any suitable configuration.

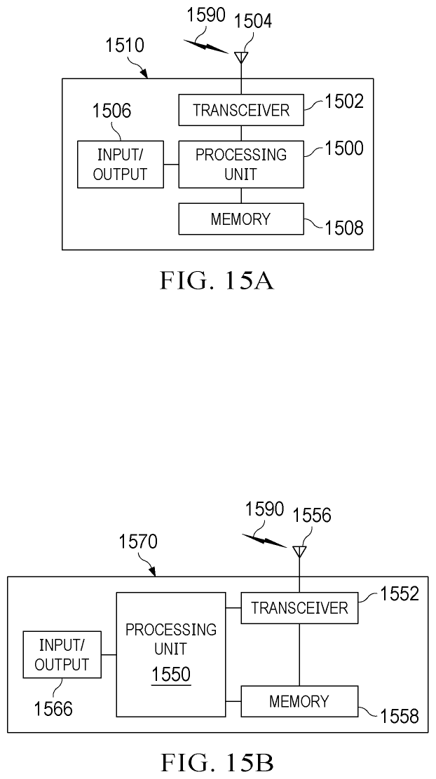

FIGS. 15A and 15B illustrate example devices that may implement the methods and teachings according to this disclosure. In particular, FIG. 15A illustrates an example ED 1510, and FIG. 15B illustrates an example base station 1570. These components could be used in the system 1400 or in any other suitable system.

As shown in FIG. 15A, the ED 1510 includes at least one processing unit 1500. The processing unit 1500 implements various processing operations of the ED 1510. For example, the processing unit 1500 could perform signal coding, data processing, power control, input/output processing, or any other functionality enabling the ED 1510 to operate in the system 1400. The processing unit 1500 also supports the methods and teachings described in more detail above. Each processing unit 1500 includes any suitable processing or computing device configured to perform one or more operations. Each processing unit 1500 could, for example, include a microprocessor, microcontroller, digital signal processor, field programmable gate array, or application specific integrated circuit.

The ED 1510 also includes at least one transceiver 1502. The transceiver 1502 is configured to modulate data or other content for transmission by at least one antenna or NIC (Network Interface Controller) 1504. The transceiver 1502 is also configured to demodulate data or other content received by the at least one antenna 1504. Each transceiver 1502 includes any suitable structure for generating signals for wireless or wired transmission or processing signals received wirelessly or by wire. Each antenna 1504 includes any suitable structure for transmitting or receiving wireless or wired signals. One or multiple transceivers 1502 could be used in the ED 1510, and one or multiple antennas 1504 could be used in the ED 1510. Although shown as a single functional unit, a transceiver 1502 could also be implemented using at least one transmitter and at least one separate receiver.

The ED 1510 further includes one or more input/output devices 1506 or interfaces (such as a wired interface to the Internet 1450). The input/output devices 1506 facilitate interaction with a user or other devices (network communications) in the network. Each input/output device 1506 includes any suitable structure for providing information to or receiving information from a user, such as a speaker, microphone, keypad, keyboard, display, or touch screen, including network interface communications.

In addition, the ED 1510 includes at least one memory 1508. The memory 1508 stores instructions and data used, generated, or collected by the ED 1510. For example, the memory 1508 could store software or firmware instructions executed by the processing unit(s) 1500 and data used to reduce or eliminate interference in incoming signals. Each memory 1508 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 15B, the base station 1570 includes at least one processing unit 1550, at least one transceiver 1552, which includes functionality for a transmitter and a receiver, one or more antennas 1556, at least one memory 1558, and one or more input/output devices or interfaces 1566. A scheduler, which would be understood by one skilled in the art, is coupled to the processing unit 1550. The scheduler could be included within or operated separately from the base station 1570. The processing unit 1550 implements various processing operations of the base station 1570, such as signal coding, data processing, power control, input/output processing, or any other functionality. The processing unit 1550 can also support the methods and teachings described in more detail above. Each processing unit 1550 includes any suitable processing or computing device configured to perform one or more operations. Each processing unit 1550 could, for example, include a microprocessor, microcontroller, digital signal processor, field programmable gate array, or application specific integrated circuit.

Each transceiver 1552 includes any suitable structure for generating signals for wireless or wired transmission to one or more EDs or other devices. Each transceiver 1552 further includes any suitable structure for processing signals received wirelessly or by wire from one or more EDs or other devices. Although shown combined as a transceiver 1552, a transmitter and a receiver could be separate components. Each antenna 1556 includes any suitable structure for transmitting or receiving wireless or wired signals. While a common antenna 1556 is shown here as being coupled to the transceiver 1552, one or more antennas 1556 could be coupled to the transceiver(s) 1552, allowing separate antennas 1556 to be coupled to the transmitter and the receiver if equipped as separate components. Each memory 1558 includes any suitable volatile or non-volatile storage and retrieval device(s). Each input/output device 1566 facilitates interaction with a user or other devices (network communications) in the network. Each input/output device 1566 includes any suitable structure for providing information to or receiving/providing information from a user, including network interface communications.

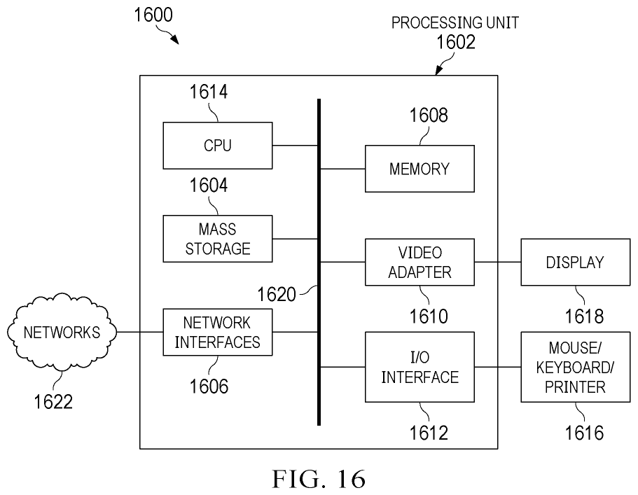

FIG. 16 is a block diagram of a computing system 1600 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1600 includes a processing unit 1602. The processing unit includes a central processing unit (CPU) 1614, memory 1608, and may further include a mass storage device 1604, a video adapter 1610, and an I/O interface 1612 connected to a bus 1620.

The bus 1620 may be one or more of any type of several bus architectures including a memory bus or memory controller, a peripheral bus, or a video bus. The CPU 1614 may comprise any type of electronic data processor. The memory 1608 may comprise any type of non-transitory system memory such as static random access memory (SRAM), dynamic random access memory (DRAM), synchronous DRAM (SDRAM), read-only memory (ROM), or a combination thereof. In an embodiment, the memory 1608 may include ROM for use at boot-up, and DRAM for program and data storage for use while executing programs.

The mass storage 1604 may comprise any type of non-transitory storage device configured to store data, programs, and other information and to make the data, programs, and other information accessible via the bus 1620. The mass storage 1604 may comprise, for example, one or more of a solid state drive, hard disk drive, a magnetic disk drive, or an optical disk drive.

The video adapter 1610 and the I/O interface 1612 provide interfaces to couple external input and output devices to the processing unit 1602. As illustrated, examples of input and output devices include a display 1618 coupled to the video adapter 1610 and a mouse, keyboard, or printer 1616 coupled to the I/O interface 1612. Other devices may be coupled to the processing unit 1602, and additional or fewer interface cards may be utilized. For example, a serial interface such as Universal Serial Bus (USB) (not shown) may be used to provide an interface for an external device.

The processing unit 1602 also includes one or more network interfaces 1606, which may comprise wired links, such as an Ethernet cable, or wireless links to access nodes or different networks. The network interfaces 1606 allow the processing unit 1602 to communicate with remote units via the networks. For example, the network interfaces 1606 may provide wireless communication via one or more transmitters/transmit antennas and one or more receivers/receive antennas. In an embodiment, the processing unit 1602 is coupled to a local-area network 1622 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method, comprising:
configuring, by a communication device, a traffic management and monitoring (TMM) transport channel for TMM message transmission between a user equipment (UE) and a user plane function (UPF) network entity; and
communicating, by the communication device, a TMM message over the TMM transport channel, wherein the TMM transport channel is a user plane-based transport channel using a TMM quality of service (QoS) flow different from a user data QoS flow for user data transmission, or using a data radio bearer (DRB) between the UE and a base station and a general packet radio service tunneling protocol (GTP) user (GTP-U) protocol between the base station and the UPF network entity.

2. The method of claim 1, wherein the TMM transport channel is the user plane-based transport channel using the DRB and the GTP-U protocol, the communication device is one of the UPF network entity, the UE or the base station.

3. The method of claim 1, wherein the TMM message is encapsulated in a GTP-U extension header with a GTP tunnel endpoint identifier (TEID) corresponding to the TMM transport channel for TMM message transmission.

4. The method of claim 1, wherein the TMM message is encapsulated in a packet data convergence protocol (PDCP) control PDU, wherein the PDCP control PDU includes a PDU type field indicating a PDU type of TMM transfer.

5. The method of claim 1, wherein the TMM message is encapsulated in a service data adaption protocol (SDAP) control PDU, and the SDAP control PDU includes a header with a field indicating that the SDAP control PDU belongs to the TMM transport channel.

6. The method of claim 1, wherein the TMM transport channel is the user plane-based transport channel using the TMM QoS flow, the communication device is one of the UPF network entity or the UE.

7. The method of claim 1, wherein the TMM message comprises a transport management message for a flow regulation report (FRR).

8. The method of claim 7, the method further comprising:
exchanging, by the UE with a core network, a capability of supporting the TMM and the FRR.

9. The method of claim 7, the method further comprising:
configuring, by the UPF network entity, the FRR that instructs a control program of the UPF network entity to change an end-to-end (E2E) flow shaping or scheduling attributes; and
sending or receiving, by the UPF network entity, the TMM message for the FRR.

10. The method of claim 7, wherein the transport management message for the FRR indicates a bandwidth between the UE and the UPF network entity or a change in bandwidth constraints for an E2E internet protocol (IP) flow.

11. The method of claim 7, further comprising:
determining, by the UE, an application corresponding to the transport management message for the FRR based on IP flow information, the IP flow information including a 5-tuple of an E2E IP flow.

12. A method, comprising:
configuring, by a communication device, a traffic management and monitoring (TMM) channel for TMM transmission between a user equipment (UE) and a user plane function (UPF) network entity; and
communicating, by the communication device, a TMM message over a transport channel, wherein the transport channel is a control plane-based transport channel using a non-access stratum (NAS) signaling between the UE and a session management function (SMF) network entity and a packet forwarding control protocol (PFCP) between the SMF network entity and the UPF network entity.

13. The method of claim 12, wherein the communication device is one of the UPF network entity, the UE, or the SMF network entity.

14. The method of claim 12, wherein the TMM message comprises a transport management message for a flow regulation report (FRR).

15. The method of claim 14, the method further comprising:
exchanging, by the UE with a core network, a capability of supporting the TMM and the FRR.

16. The method of claim 14, the method further comprising:
configuring, by the UPF network entity, the FRR that instructs a control program of the UPF network entity to change an end-to-end (E2E) flow shaping or scheduling attributes; and
sending or receiving, by the UPF network entity, the TMM message for the FRR.

17. The method of claim 14, wherein the SMF network entity authorizes a flow regulation request message for the FRR based on policies or ownership of an E2E internet protocol (IP) flow that belongs to a PDU session of the UE.

18. A communication device comprising:
at least one processor; and
a non-transitory computer readable storage medium storing programming, the programming including instructions that, when executed by the at least one processor, cause the communication device to perform operations including:
configuring a traffic management and monitoring (TMM) transport channel for TMM message transmission between a user equipment (UE) and a user plane function (UPF) network entity; and
communicating a TMM message over the TMM transport channel, wherein the TMM transport channel is a user plane-based transport channel using a TMM quality of service (QoS) flow different from a user data QoS flow for user data transmission, or using a data radio bearer (DRB) between the UE and a base station and a general packet radio service tunneling protocol (GTP) user (GTP-U) protocol between the base station and the UPF network entity.

19. The communication device of claim 18, wherein the TMM transport channel is the user plane-based transport channel using the DRB and the GTP-U protocol, the communication device is one of the UPF network entity, the UE or the base station.

20. A communication device comprising:
at least one processor; and
a non-transitory computer readable storage medium storing programming, the programming including instructions that, when executed by the at least one processor, cause the communication device to perform operations including:
configuring a traffic management and monitoring (TMM) channel for TMM transmission between a user equipment (UE) and a user plane function (UPF) network entity; and
communicating a TMM message over a transport channel, wherein the transport channel is a control plane-based transport channel using a non-access stratum (NAS) signaling between the UE and a session management function (SMF) network entity and a packet forwarding control protocol (PFCP) between the SMF network entity and the UPF network entity.
